(19) United States
(12) Patent Application Publication
(10) Pub. No.: US 2004/0033296 A1
(43) Pub. Date: Feb. 19, 2004

(54) Method of using low temperature and high/low pressure processing to preserve food products

(76) Inventors: James T. C. Yuan, Naperville, IL (US); Joseph E. Paganessi, Burr Ridge, IL (US); Edward F. Steiner, Downers Grove, IL (US); Kazue Takeuchi, Lombard, IL (US)

Correspondence Address: Linda K. Russell, Esq., AIR LIQUIDE, Suite 1800, 2700 Post Oak Blvd., Houston, TX, 77056, US

(21) Appl. No.: 10/420,928

(22) Filed: Apr. 23, 2003

Related U.S. Application Data
(60) Provisional application No. 60/380,522, filed on May 14, 2002.
(60) Provisional application No. 60/380,575, filed on May 14, 2002.

(51) Int. Cl. A23K 1/00

(52) U.S. Cl. 426/326

(57) ABSTRACT

A treatment process for preserving a food or food product against microbiological contamination, which improves the quality of such food and enhances the safety of food and food products for consumption by mammals, especially humans. The process utilizes a treatment of food or food products, or packaged food or food products, with a high pressure gas treatment process (HPP) to provide a reduction of the level of microorganisms or spores on and in such foods or food products. The method includes exposing the food or food product to a gas and/or injecting a gas into a container containing the food or food product; optionally, closing or sealing the container; and subjecting the food or food product and/or the container containing the food or food product to a temperature of less than about 50° C. and, concurrently, to more than one pressure treatment cycle at a pressure of at least about 10,000 psig. Alternatively, the HPP treatment method may instead substitute, or be combined with, one or more pressure treatment cycles at a pressure of less than about 250 psig. Optionally, the food or food product may be packaged before or after the HPP treatment. The food or food product is generally contacted with the gas under pressure conditions for a time sufficient to substantially sanitize or disinfect the food or food product following depressurization.

### CROSS-REFERENCE TO RELATED APPLICATION(S)

This application is related to and claims priority under 35 U.S.C. § 119(e) of U.S. Provisional Application Serial Nos. 60/380,522 and 60/380,575, both filed May 14, 2002, the entire contents of which are incorporated herein by reference.

### STATEMENT REGARDING FEDERALLY SPONSORED RESEARCH OR DEVELOPMENT

This invention was made without government support.

### BACKGROUND OF THE INVENTION

1. Field of the Invention

The present invention relates to processes for preserving food or a food product, and particularly to processes for preserving food or a food product against microbial contamination using a low temperature and high pressure process and a low temperature and low pressure process.

2. Brief Description of Art

Food and food products, including packaged foods and food products, are generally subject to two main problems: microbial contamination and quality deterioration. The primary problem regarding food spoilage in public health is microbial growth. If pathogenic microorganisms are present, then growth of such microorganisms can potentially lead to food-bore outbreaks and significant economic losses. Since 1997, food safety concerns have increasingly been brought to the consumers' attention, and those concerns have become even stronger today. Recent outbreaks from Salmonella and E. coli 0157:H7 have increased the focus on food safety from a regulatory perspective, as well. A report issued from National Research Council (NRC) in 1988 indicated that there were approximately 9,000 human deaths a year from 81 million annual cases of food poisoning. A recent study completed by the Centers for Disease Control and Prevention (CDC) estimated that food-borne diseases cause approximately 76 million illnesses, 325,000 hospitalizations and 5,000 deaths annually in the U.S. Those numbers reveal the dramatic need for effective means for preserving food and food products in order to ensure food safety.

Currently, food manufacturers use different technologies, such as heating, to eliminate, retard, or prevent microbial growth. However, effective sanitation depends on the product/process type, and not all currently available technology can deliver an effective reduction of microorganisms. Instead, another level of health problems may be created, or the quality of the treated food may deteriorate. For example, chlorine has been widely used as a sanitizer of choice since World War I. However, concerns regarding the safety of carcinogenic and toxic byproducts of chlorine, such as chloramines and trihalomethanes, have been raised in recent years. Another example is heat treatment. Even though heat is very efficient in killing bacteria, it also destroys some nutrients, flavors, or textural attributes of food and food products.

Ozone has also been utilized as a means of reducing spoilage microorganisms in food and food products. Its effectiveness is generally compromised, however, by high reactivity and relatively short half life in air. Ozone decomposition is also accelerated by water, certain organic and inorganic chemicals, the use of higher temperatures and pressures, contact with surfaces, particularly organic surfaces, and by turbulence, ultrasound and UV light. As a consequence, unlike other gases, ozone is not generally suitable for storage for other than short periods of time. The use of gaseous ozone for the treatment of foods also presents certain additional problems, including non-uniform distribution of ozone in certain foods or under certain storage conditions. As a result, the potential exists for overdosing in areas close to an ozone entry location, while those areas remote from the entry location may have limited exposure to an ozone containing gas. A further important consideration in the use of ozone is the generally relatively high cost associated with ozone generation on a commercial scale, including the costs associated with energy and the destruction of off-gas ozone.

Similarly, carbon dioxide has been used as a means to inhibit the growth and metabolism of microorganisms, as well. See, e.g., the review of such studies presented in the Journal of Applied Bacteriology, 1989, 67, 109-136. The effect of CO₂ under pressure, and the release of pressure, upon bacteria has been investigated in other studies (see, e.g., the Journal of Bacteriology, vol. XXVI, no. 2, 201-210, in which such effects were investigated for E. coli no. 463).

High pressure or ultra-high pressure processing (HPP) has also been applied to treat food and food products and to improve food safety against microbial contamination. In general, HPP treatment involves the high pressure processing of food to disrupt microbial cells or deactivate enzymes in the food. For example, in U.S. Pat. No. 5,393,547, a method is described for inactivating enzymes in food products by exposing the food to pressurized CO₂. However, the process requires that a carbonic acid solution be produced in the aqueous phase of the food by exposure of the food to CO₂ for a sufficient time such that a sufficiently low pH is produced to inactivate the enzymes. As exemplified, such times are at least one to two hours.

U.S. Pat. No. 6,331,272 further describes a method and membrane system for sterilizing and preserving liquids using CO₂. The method is said to destroy microorganisms and provide for the deactivation of enzymes by the use of a system in which a flowing liquid, such as a juice, is contacted with the CO₂, the liquid and the CO₂ being separated by a porous membrane, e.g., a hollow fiber membrane. CO₂ is continuously recirculated without depressurization at pressures said to be typically in the range of about 1000 to about 3000 psi.

Although HPP may be utilized to treat food against microbial contamination, there remain several concerns over its use. For example, the treatment may be ineffective against bacterial spores. HPP treatment may also induce undesired effects on certain enzymes and/or enhance undesirable enzymatic activities. In addition, the combination of heat treatment with HPP may lead to a deterioration of nutrients, quality or taste, texture and/or appearance. The added expense of high energy consumption by the use of heat treatment is also undesirable.

In light of the foregoing problems associated with the treatment of foods against microbial contamination, a need exists for improvement in the sanitizing/disinfecting of foods and food products while at the same time maintaining or improving the quality and enhancing the safety of such foods.

### OBJECTS AND SUMMARY OF THE INVENTION

It is an object of the present invention to provide a high pressure process for preserving foods and food products which demonstrates improved biocidal efficacy, improves the quality of such food and enhances the safety of food for consumption by mammals, especially humans.

In accordance with one aspect of the invention, a method of treating a food or food product and/or a packaged food or food product against microbial contamination is provided, comprising treating the food or food product using a high pressure process (HPP), which comprises subjecting a food or food product to a gas treatment by exposing the food or food product to a gas and/or injecting a gas into a container comprising the food or food product; optionally, closing or sealing the container; and subjecting the food or food product and/or the container comprising the food or food product to a temperature of less than about 50° C. and, concurrently, to more than one pressure treatment cycle at a pressure of at least about 10,000 psig.

In another aspect of the invention, a method of treating a food or food product and/or a packaged food or food product against microbial contamination is provided, comprising treating the food or food product using a high pressure process (HPP), which comprises subjecting a food or food product to a gas treatment by exposing the food or food product to a gas and/or injecting a gas into a container comprising the food or food product; optionally, closing or sealing the container; and subjecting the food or food product and/or the container comprising the food or food product to a temperature of less than about 50° C. and, concurrently, to one or more pressure treatment cycles at a pressure of greater than about 25 psig to less than about 250 psig.

The food or food product is generally contacted with the gas under pressure conditions for a time sufficient to substantially sanitize or disinfect the food or food product following depressurization. Optionally, the food or food product may be packaged before or after the HPP treatment.

In order to improve the quality and enhance the safety of food and food products, the invention utilizes a high pressure process to provide a synergistic effect on the destruction or inactivation of microorganisms, as well as a reduction of the level of microorganisms on and in such foodstuffs, through the use of HPP and gas treatments.

It is known that many bacteria have the ability to repair themselves, especially if they are spore-formers. Spores are generally adaptive to even steam temperatures such that a single treatment may not be effective to kill or substantially reduce the level of microorganisms. If one treatment alone does not kill all microorganisms present, a subsequent treatment or process may have a better chance of being effective, as the cells generally get weaker and weaker with accumulated stress. The use of an HPP treatment for food and food products, in conjunction with another process, e.g., a modified atmosphere packaging process, provides a multi-technologies approach to reducing the level of microorganisms associated with food and food products which has advantages over the use of a single technology. The inventive process therefore allows food processors to reduce the amount of additional processing needed, such as the temperature and/or amount of cooking time, with a resulting enhancement in food quality and safety.

### BRIEF DESCRIPTION OF THE FIGURES

FIG. 1 schematically illustrates a chamber for gas flushing of samples and sample pouches.

FIG. 2 schematically illustrates an inner and outer sample pouch arrangement as utilized in the examples.

FIG. 3 depicts a schematic of a pressure treatment chamber for batch HPP treatment of food or food products.

### DETAILED DESCRIPTION OF THE PREFERRED

Embodiments of the Invention In accordance with the present invention, a process is provided for treating a food or food product against microbial contamination by disinfecting and/or sanitizing the food or food product using a high pressure process (HPP) treatment at a low temperature. The HPP treatment may be used prior to, during all of, or a portion of a process for treating a food or food product, or thereafter, to eliminate or significantly reduce the content of microorganisms, bacteria or fungal spores, or viruses in or on the food or food product.

As used herein, the phrase “food or food product” generally refers to all types of foods, including, but not limited to, meats, including ground meats, poultry, seafood, produce including vegetables and fruit, dry pasta, breads and cereals and fried, baked or other snack foods. The food may be in solid or liquid form, such as beverages or juices. The HPP treatment may be used in conjunction with any food that is able to support microbial, i.e. fungal, bacterial or viral growth, including unprocessed or processed foods. The food or food product must generally be compatible with the HPP treatment according to the invention.

The terms “sanitize” and disinfect”, as well as variations thereof, generally mean the reduction of the microbial and/or spore content of food. The terms “substantially sanitize and “substantially disinfect” refer to the attainment of a level of microorganisms and/or spores in the food such that the food or food product is safe for consumption by a mammal, particularly by humans. Generally, as used herein, these terms refer to the elimination of at least about 90.0 to 99.9% of all microorganisms and/or spores, including pathogenic microorganisms, in the treated food or food product. Preferably, at least about 90.0 to 99.99%, and more preferably at least about 90.0 to 99.999% of such microorganisms and/or spores, are eliminated.

It is intended that the HPP and gas treatments provide a means of treating a food or food product against microbial contamination. Generally, the term “microbial contamination” refers to undesired pathogenic and spoilage microorganisms. However, as the skilled artisan will appreciate, certain organisms may be desired (e.g. active yeasts) for particular foods, while the presence of such organisms in or on other foods may be undesirable. It is therefore not intended that all microbes necessarily be eliminated or reduced for all foods, since the presence of certain microorganisms may be desired for a particular food or food product.

The use of HPP and gas treatments against microbial contamination is further intended to include reducing the level of activity of such microorganisms. In this context, the process may provide for killing, reducing the number of, or injuring or harming such microorganisms, such that the growth rate or ability of the microorganisms to withstand additional HPP and gas treatment (or other anti-microbial treatments) is reduced.

In general, the process according to the invention exposes a food or food product, either of which may be optionally packaged before or after treatment, to an effective amount of a gas under pressure conditions for a time sufficient to substantially sanitize or disinfect the food or food product following depressurization. Depending on the pressure and/or the gas utilized, as well as the type and form of the food, one or more pressure treatment cycles, i.e., exposure of the food or food product to the gas under pressure followed by depressurization, may be utilized. For pressures above about 10,000 psig, it is preferred that more than one pressure treatment cycle be utilized. For pressures of less than about 250 psig, one or more pressure treatment cycles may be utilized. Combinations of one or more pressure treatment cycle(s) above about 10,000 psig with one or more pressure treatment cycle(s) at pressures of less than about 250 psig are also possible.

The term “pressure treatment cycle” generally refers to the use of the desired pressure condition for exposure of the food or food product to the gas under pressure, followed by depressurization. Although the depressurization is typically performed by reducing the pressure to about atmospheric pressure, it is also possible to depressurize to a pressure greater than atmospheric (e.g. about 25 psig, or, alternatively, within the range of about 1-3 atm), followed by re-pressurization to start another pressure treatment cycle. It is preferred that such depressurization occur rapidly, i.e., over a short period of time, typically on the order of seconds (e.g., from greater than 0 to about 15 seconds). Unless otherwise indicated, pressures mentioned herein are gage pressures.

Although not intended to be bound by a theoretical understanding of the effects of HPP treatment on microorganisms, it is thought that high pressure increases the solubility of gas in microbial cells such that a sharp drop in pressure at the end of the HPP pressure treatment cycle causes gas to form in the cells as the gas solubility decreases, thereby causing a bursting of the cell walls and irreversible death of the cells. By the application of more than one treatment cycle, the biocidal efficacy of HPP treatment may be increased significantly. As used herein, the term “biocidal efficacy” generally refers to the effectiveness of the HPP treatment and/or the gas treatment to reduce the number of microorganisms on or in the food or food product, or to reduce the growth rate of microorganisms on or in the food or food product.

The HPP gas or gas mixture may be selected from NO, N₂O, CO₂, CO, He, H₂, N₂, O₂, a noble gas or a mixture thereof. Generally, inert gas or inert gases may be present in the HPP process gas. As used herein, the term “inert gas” refers to any non-oxidative or non-reactive gas and includes gases such as nitrogen, argon, krypton, xenon and neon or any mixture thereof.

The food or food product is generally contacted with the gas under pressure conditions at a temperature below about 50° C., preferably below about 40° C., and more preferably from about 10° C. to below about 40° C. The use of different temperatures or pressure conditions, depending on the number of pressure treatment cycles utilized, is also possible.

The food or food product is intended to be contacted with the HPP gas for a time sufficient to substantially sanitize or disinfect the foodstuff. While the time periods necessary to achieve this condition will vary depending on the particular food or food product, whether the food or food product is packaged, the type of microorganism treated, and the amount of subsequent treatment the food is intended to be subjected to, e.g., cooking or additional pressure treatment cycles, in general, the time period per pressure treatment cycle ranges from about 5 seconds to about 1 hour, preferably from about 15 seconds to about 30 minutes and more preferably from about 15 seconds to about 10 minutes. The amount of treatment time for spores is generally greater.

It is preferred that the biocidal efficacy of the method is synergistically improved as compared with pressure treatment alone and/or gas treatment alone of the food or food product. By the term “synergistically improved”, it is meant that the biocidal efficacy, i.e., the effectiveness of the HPP treatment and/or the gas treatment to reduce the number of microorganisms on or in the food or food product, or to reduce the growth rate of microorganisms on or in the food or food product, is improved compared with pressure treatment and/or gas treatment alone of the food or food product.

The food or food product may be subjected to a batch treatment with the HPP gas or may be contacted with the gas in a continuous or semi-batch process. A suitable gas concentration for use in such a batch, continuous, or semi-batch process is in the range of about 0.2% to 100% for the exposure periods noted above. Other combinations of gas concentrations and exposure periods may also be used, however, if desired, to sanitize/disinfect the food or food product. Means for increasing the contact of the HPP gas with the food, such as, gas diffusers for liquids, or means for injecting gas into a solid or liquid food or food product, may also be utilized. In one aspect of the invention, the food or food product may be exposed to the gas by injection of the gas into the food or food product or by injection of gas into the ambient atmosphere surrounding the food or food product and/or injecting the gas into a container containing the food or food product.

The HPP treatment may also be combined with other processes. For example, a cooking process, such as in an oven or other closed or controlled environment, may be utilized in addition to the HPP treatment. Other heat treatment cooking processes, such as grilling (e.g. in the case of meats and other suitable foods), boiling, or frying, may be utilized without limitation in conjunction with or following the HPP treatment. The cooking process may, e.g., include other known cooking steps or processes, such as, e.g., microwave treatment, or convective or radiative heating. The use of heated gases, including steam, is also possible, and may be preferred for certain foods. Such cooking processes may also be conducted at atmospheric pressure, under vacuum, or at a pressure up to about 300,000 psi. A gaseous atmosphere comprising, e.g., air, oxygen, carbon dioxide, carbon monoxide, nitrogen, argon, or mixtures thereof, may also be utilized during the cooking process.

The use of additional expensive processing techniques, such as, e.g., membrane contactors according to U.S. Pat. No. 6,331,272, are not required in the present invention, and are preferably excluded.

The process of the invention may optionally include packaging of the food or food product comprising placing the food or food product in a container and sealing the container. A vacuum may be optionally applied to the container to remove air or other gas from the container. A purge gas may be further optionally injected into the container, either with or without the use of a vacuum step. The purge gas may be applied before, after or both before and after the use of a vacuum step. The purge gas may be, e.g., nitrogen, carbon dioxide, carbon monoxide, argon, krypton, xenon, neon or a mixture thereof.

In a preferred embodiment, the food or food product is treated by HPP, is subsequently placed in a container, a vacuum is applied to the container to remove air or other gas from the container, and the container is sealed to maintain the vacuum in the container.

The optional container used to contain the food or food product is not particularly limited and includes, e.g., disposable and reusable containers of all forms, including those which may be microwavable and/or oven-proof. The container may include a cover or cap designed for the container or may be closed or sealed with a permeable or impermeable film or metal foil.

The present invention may be advantageously used to destroy viruses, bacteria and/or fungi. Preferably, the microorganisms destroyed are those causing food-borne illnesses. As used herein, the term “food-borne” illness means any single or combination of illnesses caused by microorganisms in mammals consuming foods containing those microorganisms.

Examples of bacteria causing such illnesses are various species of Salmonella, Staphylococcus, Streptococcus and Clostridium. For example, Escherichia coli, including E. coli 0157:H7, Salmonella typhimurium, Salmonella Schottmulleri, Salmonella choleraesuis, Salmonella enteritidis, Staphylococcus aureus, Streptococcus faecalis, Clostridium botulinum and Clostridium perfringens may be noted. Generally, the present invention may be advantageously used against any bacteria which produce a toxin or an enzyme or both, e.g., as a mechanism of pathogenicity.

For example, hyaluronidase, an enzyme that digests the intracellular cement, hyaluronic acid, is produced by some pathogenic strains of Staphylococci, Streptococci and Clostridia.

As examples of toxins, the neurotoxin of Clostridium botulinum and the enterotoxin produced by Staphylococcus aureus may be noted.

An example of fungi causing mycotoxicosis, a collective term for diseases induced by consumption of food made toxic by the growth of various fungi, are Aspergillus flavus in peanuts, peanut butter, rice, cereal grains and beans, for example, to produce any one of the many known aflatoxins. Another example is Aspergillus ochraceus, which may grow in corn, grain, peanuts, Brazil nuts, and cottonseed meal, for example, to produce the toxins, ochratotoxin A and B. Yet another example is a mycotoxin released by Penicillium toxicarium growing on rice which causes paralysis, blindness and death in experimental animals. Still another example is Fusarium graminearum.

Having described the present invention, reference will now be made to certain examples provided solely for the purposes of illustration. These examples are not to be interpreted as limiting the scope of the invention or the claims.

### EXAMPLES

### Example 1

Generic Escherichia coli or Baker's yeast was grown in Tryptic soy broth and Lactobacillus plantarum ATCC8014 was grown in MRS broth at 35° C. for 24 hours. Either E. coli, Baker's yeast, L. plantarum or Bacillus subtilis spores were diluted in Sorensen's phosphate buffer at pH 7.0 at 2° C.

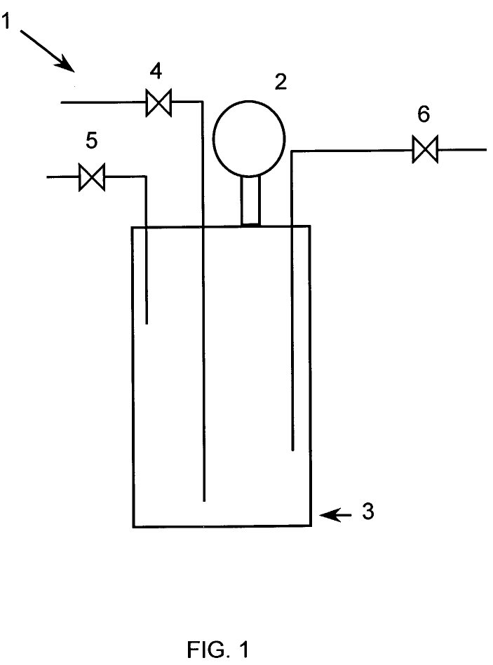

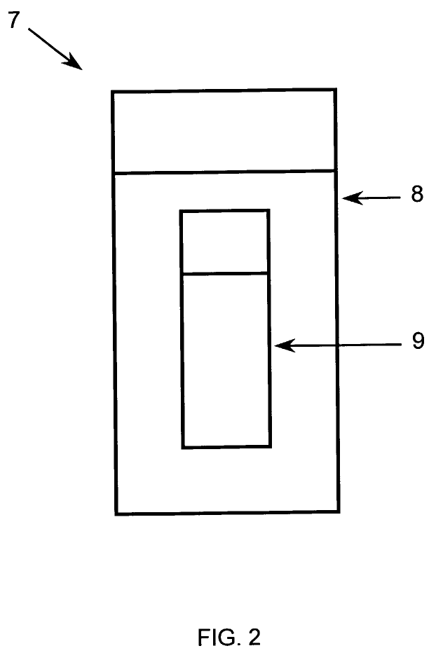

An inoculum solution was placed in a stainless steel vessel placed in ice slurry and flushed with oxygen or carbon dioxide at 69 kPa gage (10 psi gage) for 10 min in a gas flushing chamber (FIG. 1). In FIG. 1, the gas flushing chamber 1, includes pressure gage 2, vessel 3, and valves 4, 5, and 6. During the flushing, valve 6 was closed and valves 4 and 5 were opened. Valve 4 was connected to a flow meter which was connected to a gas source. Gas entered through valve 4 and exited through valve 5. Needle bulbs on valves 4 and 5 were used to adjust the flow rate of gas and the pressure inside the vessel 3. During the preparation of pouch samples, valve 4 was closed and valve 5 was connected directly to the gas source. Gas was allowed to set for 3 min. Once the inoculum was flushed with the gas, approximately 10 ml of the samples were withdrawn into a pouch made from gas impermeable films (FIG. 2). Samples were drawn through valve 6 into the inner pouch 9 of the sample pouch 7. The pouch was sealed immediately with a heat sealer and placed inside of another pouch. The outer pouch 8 was filled with 10 ml water and heat-sealed (FIG. 2). The headspace was kept to a minimum during the sealing of the pouches. Pouches were stored at 2° C. for overnight prior to HPP. Pouches of inoculums prior to the gas flushing were also prepared and stored at 2° C.

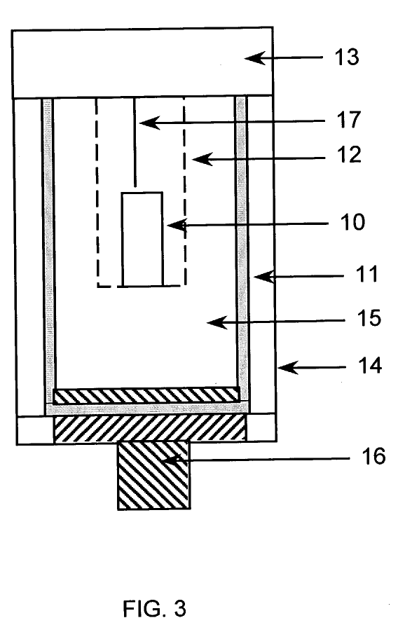

The sample pouches were processed with a Quintus Food Processor Model 6 (Flow International Co., Columbus, Ohio) under various pressures, temperature and time combinations. A schematic illustration of the pressurizing chamber and sample arrangement is shown in FIG. 3. The HPP apparatus (FIG. 3) included a high-pressure vessel and its upper closure 13, a pressure generating system 16 (e.g. a piston), a temperature control device and a material-handling system. Samples 10 were placed in an inner basket 12 located inside of the pressure chamber 11 which was surrounded by a water jacket 14. The pressurization chamber was filled with a mixture of water and glycol (50:50), which served as a pressure transmitting fluid 15. The vessel was closed and the pressure was generated by the compression of the piston 16. Once the pressure reached the target, it was held at that pressure for a predetermined process time. The temperature was measured by means of a thermocouple 17. At the end of the process time, the pressure was released. For the double pulse operation, the chamber was re-pressurized following the initial depressurization. When different pressures were used for two pulses, the temperatures of the samples and the pressure transmitting fluid were adjusted to a desired initial temperature to prevent excessive heating. Samples were cooled immediately after HPP treatment by placing on an ice slurry.

The numbers of surviving cells and/or spores were determined before and after HPP treatment by plating serially diluted samples on E. coli/Coliform Petrifilm for E. coli, Aerobic plate count (APC) Petrifilm for B. subtilis, Yeast and Mold (YM) Petrifilm for Baker's yeast, and Redi-gel MRS plates for L. plantarum. E. coli/Coliform and APC Petrifilm were incubated aerobically at 35° C. for 48 hours. YM Petrifilm was incubated aerobically at 20-25° C. for 5 days. Redi-gel plates were incubated in a 5% CO₂ chamber at 35° C. for 48 hours. Log reductions were determined as differences between counts before and after HPP treatment.

The advantages of using gases during HPP treatment for microbial inactivation are shown in Table 1. Specifically, the addition of gases such as oxygen and carbon dioxide synergistically improved the biocidal efficacy of HPP treatment against E. coli, L. plantarum, and Baker's yeast. For example, as indicated in Table 1, the addition of carbon dioxide provided a log reduction of L. plantarum by about 5 logs (10⁵ folds) by HPP treatment at 60 Kpsi and 20° C. for 10 min. In addition, the incorporation of oxygen enhanced the inactivation of B. subtilis spores, which are generally difficult to inactivate, by about 0.7 log by HPP treatment at 30 Kpsi and 40° C. for 30 min followed by HPP treatment at 70 Kpsi and 40° C. for 2 min.

TABLE 1
Single Pulse Effects of Various Gases in HPP

| | | | | | Log reduction [log cfu/ml] | | |
|---|---|---|---|---|---|---|---|
| | | | Flushing | | | Reduction | |
| Process conditions | | | method | | Reduction | without | Difference |
| Kpsi | ° C. | min | (psi) | Target | by gas | gas | (logs) |
| 70 | 10 | 10 | 10 | E. coli | O₂,8.10¹ | 5.41 | 2.69 |
| 60 | 20 | 5 | 10 | L. plantarum | CO₂, 5.71 | 1.77 | 3.94 |
| 60 | 20 | 10 | 10 | L. plantarum | CO₂, 7.46 | 2.49 | 4.97 |
| 45 | 20 | 5 | 10 | Baker's yeast | CO₂, 590¹ | 4.62 | 1.28 |
| 30² | 40 | 30 | 10 | B. subtilis spores | O₂, 3.23 | 2.57 | 0.66 |
| 70 | | 2 | | | | | |

¹complete inactivation.
²30 Kpsi for 30 min, followed by 70 Kpsi for 2 min.

### Example 2

Three strains of generic Escherichia coli were grown in Tryptic soy broth at 35° C. for 24 hours. Three strains were mixed in equal ratio and were diluted in Sorensen's phosphate buffer at pH 7.0 at 2° C.

An inoculum solution was placed in a stainless steel vessel placed in an ice slurry and flushed with carbon dioxide at ambient pressure for 10 min (FIG. 1). Gas was allowed to set for 3 min. Once the inoculum was flushed with carbon dioxide, approximately 10 ml of the samples were withdrawn into a pouch made from gas impermeable films (FIG. 2). The pouch was sealed immediately with a heat sealer and placed inside of another pouch. The outer pouch was filled with 10 ml water and heat-sealed (FIG. 2). The headspace was kept minimum during the sealing of pouches. Pouches were stored at 2° C. for overnight prior to the HPP. Pouches of inoculums prior to the gas flushing were also prepared and stored at 2° C.

The sample pouches were processed with a Quintus Food Processor Model 6 (Flow International Co., Columbus, Ohio) at 70 Kpsi at 10° C. for the total process time of 5 min with or without pulse. For the double pulse operation, the chamber was re-pressurized following the initial depressurization. The samples were cooled immediately after HPP treatment by placing on an ice slurry.

The numbers of surviving cells were determined before and after HPP processing by plating serially diluted samples on E. coli/Coliform Petrifilm. Plates were incubated aerobically at 35° C. for 48 hours. Log reductions were determined as differences between counts before and after HPP treatment.

Table 2 shows that carbon dioxide and/or pulsing can synergistically improve the biocidal efficacy of HPP against E. coli compared to HPP treatment without gases or pulsing. In particular, the application of double pulses and/or the addition of carbon dioxide enhanced the biocidal efficacy of HPP treatment against E. coli compared to HPP without pulsing or carbon dioxide. For example, addition of carbon dioxide improved the inactivation (shown as log reduction) of E. coli by single pulse HPP treatment by about 2 logs. Pulsing improved the degree of the inactivation of E. coli by about 2.4 logs in the presence of carbon dioxide and about 3 logs in the absence of carbon dioxide. In combination, pulsing and carbon dioxide enhanced the biocidal efficacy of HPP treatment by about 4 logs compared to treatment without pulsing and gas.

TABLE 2
Effects of Gas and Double Pulse for the Inactivation of E. coil
at 70 Kpsi at 10° C.

Log reduction [log cfu/ml]

| | Process | Reduction in | | |
|---|---|---|---|---|
| | Time | the presence | Reduction without | |
| Pulse | (min) | of CO₂ | gases | Differences¹ |
| single | 5 | 4.52 | 3.01 | 1.51 |
| double | 2.5 + 2.5 | 6.89 | 6.08 | 0.81 |

| | | | |
|---|---|---|---|
| Differences² | 2.37 | 3.07 | — |

¹Differences = Reduction in the presence of CO₂ - Reduction without gases
²Differences = Reduction by double pulse - Reduction by single pulse

### Example 3

Three strains of generic Escherichia coli were grown in Tryptic soy broth at 35° C. for 24 hours. Three strains were mixed in equal ratio and were diluted in Sorensen's phosphate buffer at pH 7.0 at 2° C.

An inoculum solution was placed in a stainless steel vessel placed in ice slurry and flushed with carbon dioxide, nitrous oxide, argon, nitrogen or helium at ambient pressure for 10 minutes (FIG. 1). Gas was allowed to set for 3 min. Once the inoculum was flushed with the gas, approximately 10 ml of the samples were withdrawn into a pouch made from gas impermeable films (FIG. 2). The pouch was sealed immediately with a heat sealer and placed inside of another pouch. The outer pouch was filled with 10 ml water and heat-sealed (FIG. 2). The headspace was kept to a minimum during the sealing of the pouches. The pouches were stored at 2° C. for overnight prior to the HPP treatment. Pouches of inoculums prior to the gas flushing were also prepared and stored at 2° C.

The sample pouches were processed with a Quintus Food Processor Model 6 (Flow International Co., Columbus, Ohio) at 70 Kpsi at 40° C. for the total process time of 2 min with or without pulse. For the double pulse operation, the chamber was re-pressurized following the initial depressurization. The samples were cooled immediately after HPP treatment by placing on an ice slurry.

The numbers of surviving cells were determined before and after HPP processing by plating serially diluted samples on E. coli/Coliform Petrifilm. Plates were incubated aerobically at 35° C. for 48 hours. Log reductions were determined as differences between counts before and after HPP treatment.

Table 3 shows that pulsing synergistically improves the biocidal efficacy of HPP in the presence of the gases compared to that of without gases, thereby providing more choices for the use of packaging conditions for foods. For example, pulsing in the presence of argon enhanced the inactivation (shown as log reduction) of E. coli by HPP treatment by about 5.6 logs. In addition, pulsing in the presence of gases such as carbon dioxide, nitrous oxide, argon, and helium enabled the complete inactivation of 10⁸ cfu/ml E. coli cells by the HPP treatment at 70 Kpsi and 40° C. in a very short process period of 2 min (i.e., 1 min per cycle, or 1 min+1 min).

TABLE 3
Effects of Double Pulse for the Inactivation of E. coil
at 70 Kpsi at 40° C.

Log reduction [log cfu/ml]

| | Pulse Process Time | | |
|---|---|---|---|
| | Single, | Double, | |
| Gas | 2 min | 1 min + 1 min | Differences¹ |
| CO₂ | 7.50 | 8.18² | 0.68 |
| N₂O | 3.47 | 8.18² | 4.71 |
| Ar | 2.54 | 8.18² | 5.64 |
| N₂ | 4.16 | 8.08 | 3.92 |
| He | 3.29 | 8.18² | 4.89 |

¹Differences = Reduction by double pulse - Reduction by single pulse.
²inactivation.

While the invention has been described in detail by reference to specific embodiments, the skilled artisan will appreciate that various modifications, substitutions, omissions and changes may be made, and equivalents employed, without departing from the spirit of the invention or the scope of the appended claims.

What is claimed is:

1. A method of treating a food or food product and/or a packaged food or food product against microbial contamination which comprises:
subjecting a food or food product to a gas treatment by exposing the food or food product to a gas and/or injecting a gas into a container containing the food or food product;
optionally, closing or sealing the container; and
subjecting the food product and/or the container containing the food product to a temperature of less than about 50° C. and, concurrently, to more than one pressure treatment cycle at a pressure of at least about 10,000 psig.

2. The method of claim 1, wherein the biocidal efficacy of said method is synergistically improved as compared with said pressure treatment alone or said gas treatment alone of said food or food product.

3. The method according to claim 1, wherein the container containing the food or food product is an open container during the step of injecting the gas into the container and/or during one or more of the pressure treatment cycles.

4. The method according to claim 1, wherein the container containing the food or food product is a closed or sealed container during the step of injecting the gas into the container and/or during one or more of the pressure treatment cycles.

5. The method according to claim 1, wherein the pressure treatment cycle comprises subjecting the food or food product and/or the container containing the food or food product to a pressure of at least about 10,000 psig, followed by depressurization to a pressure in the range of about 1-3 atm.

6. The method according to claim 1, wherein said food or food product is subjected to said more than one pressure treatment cycles for a sufficient time to substantially sanitize the food or food product.

7. The method according to claim 1, the container containing the food or food product is evacuated prior to injecting the gas.

8. The method according to claim 1, wherein the gas is selected from NO, N₂O, CO₂, CO, He, H₂, N₂, O₂, a noble gas or a mixture thereof.

9. The method according to claim 1, wherein the temperature to which the food or food product and/or the container containing the food or food product is subjected is less than 40° C.

10. The method according to claim 1, wherein the food or food product is a solid or a liquid.

11. The method according to claim 1, wherein the container containing the food or food product is sealed with an impermeable film, a permeable film or a cap.

12. The method according to claim 1, wherein the gas comprises an inert gas and/or an anti-microbial gas.

13. The method according to claim 1, further comprising
subjecting the food or food product and/or the container containing the food or food product to a temperature of less than about 50° C. and, concurrently, to one or more pressure treatment cycles at a pressure of greater than about 25 psig to less than about 250 psig.

14. A food or food product or a packaged food or food product treated according to the method of claim 1.

15. A method of treating a food or food product and/or a packaged food or food product against microbial contamination which comprises:
subjecting a food or food product to a gas treatment by exposing the food or food product to a gas by injection of a gas into the food or food product or by injection of a gas into the ambient atmosphere surrounding the food or food product and/or injecting a gas into a container containing the food or food product;
optionally, closing or sealing the container; and
subjecting the food or food product and/or the container containing the food or food product to a temperature of less than about 50° C. and, concurrently, to one or more pressure treatment cycles at a pressure of greater than about 25 psig to less than about 250 psig.

16. The method of claim 15, wherein the biocidal efficacy of said method is synergistically improved as compared with said pressure treatment alone or said gas treatment alone of said food or food product.

17. The method according to claim 15, wherein the container containing the food or food product is an open container during the step of injecting the gas into the container and/or during one or more of the pressure treatment cycles.

18. The method according to claim 15, wherein the container containing the food or food product is a closed or sealed container during the step of injecting the gas into the container and/or during one or more of the pressure treatment cycles.

19. The method according to claim 15, wherein the pressure treatment cycle comprises subjecting the food or food product and/or the container containing the food or food product to a pressure of greater than about 25 psig to less than about 250 psig, followed by depressurization to a pressure in the range of about 1-3 atm.

20. The method according to claim 15, wherein said food or food product is subjected to said one or more pressure treatment cycles for a sufficient time to substantially sanitize the food or food product.

21. The method according to claim 15, wherein the container containing the food or food product is evacuated prior to injecting the gas.

22. The method according to claim 15, wherein the gas is selected from NO, N₂O, CO₂, CO, He, H₂, N₂, O₂, a noble gas or a mixture thereof.

23. The method according to claim 15, wherein the temperature to which the food or food product and/or the container containing the food or food product is subjected is less than 40° C.

24. The method according to claim 15, wherein the food or food product is a solid or a liquid.

25. The method according to claim 15, wherein the container containing the food or food product is sealed with an impermeable film, a permeable film or a cap.

26. The method according to claim 15, wherein the gas comprises an inert gas and/or an anti-microbial gas.

27. The method according to claim 15, further comprising
subjecting the food product and/or the container containing the food product to a temperature of less than about 50° C. and, concurrently, to one or more pressure treatment cycles at a pressure of at least about 10,000 psig.

28. A food or food product or a packaged food or food product treated according to the method of claim 15.
